(19) United States
(12) Patent Application Publication
(10) Pub. No.: US 2013/0067529 A1
(43) Pub. Date: Mar. 14, 2013

(54) RECORDABLE DIGITAL TV SET-TOP BOX

(71) Applicants: Han Chung CHANG, Taipei (TW); Chun Cheng CHEN, Taipei (TW)

(72) Inventors: Han Chung CHANG, Taipei (TW); Chun Cheng CHEN, Taipei (TW)

(73) Assignee: Tatung Technology Inc., Taipei (TW)

(21) Appl. No.: 13/323,851

(22) Filed: Dec. 13, 2011

(30) Foreign Application Priority Data
Sep. 14, 2011 (TW) 100217210

(51) Int. Cl. H04N 21/41

(52) U.S. Cl. 725/152

(57) ABSTRACT

A digital TV set-top box includes a casing, a fixing frame, an adapter board, a hard disk drive, and a sliding frame. The casing is provided with an opening, and the fixing frame is arranged with the hard disk drive. Since the sliding frame is smaller than the opening of the casing, the sliding frame can pass through the opening and be slidably arranged between two chutes of the fixing frame, and a connecting head of the hard disk drive can be correspondingly plugged into the adapter board so as to establish an electrical connection. As such, the present invention provides a TV set-top box that the hard disk drive can be assembled therewith or disassembled therefrom easily, so that the hard disk drive of the digital TV set-top box can be maintained or upgraded without the need of removing the whole upper casing of the set-top box.

### BACKGROUND OF THE INVENTION

1. Field of the Invention

The present invention relates to a recordable digital TV set-top box, and more particularly, to a digital TV set-top box containing a hard disk drive able to easily attach thereto or detach therefrom.

2. Description of Related Art

A large number of people acquire information from TV (television) programs, and many companies provide diversified services through TV programs. When an enormous amount of services and functions are produced, since conventional televisions can only receive conventional analog signals, signals of 6 MHz channel set up as a standard for digital televisions cannot be received, making users unable to enjoy high-quality TV viewing, sound, and supporting information. Therefore, suppose one wishes to watch digital TV programs from a conventional television, he or she has to install a digital TV set-top box (STB) or so-called video transformation box. With the help of the digital TV set-top box, digital TV signals are received and decoded, then transmitted to conventional televisions or flat-screen televisions through cable, AT or SV signals including cable TV, satellite TV, terrestrial TV broadcasting, and IP/DSL TV signals. Ever since digital TV broadcasting, digital televisions (DTV) have become a new generation of consumption products.

However, for conventional digital TV set-top boxes, a hard disk drive is fixed inside the set-top box. In case the hard disk drive is damaged or malfunctions, the operating system, software or firmware inside the hard disk drive will not be able to be actuated. Or in case the operating system, software or firmware has a new version to be upgraded, since the program may sometimes be too large, upgrading via downloading from the network becomes impossible, or even the downloading itself turns out to be time consuming and, disconnection takes place quite often. As a result, the whole upper casing of a set-top box has to be removed so as to take out the hard disk drive to be repaired or to deliver the hard disk drive for installing new software. This makes maintenance or upgrading of the hard disk drive unable to meet the requirement of economic efficiency. It is clear, therefore, that to develop a digital TV set-top box containing a hard disk drive able to easily attach thereto or detach therefrom is urgently required.

### SUMMARY OF THE INVENTION

The present invention is to provide a recordable digital TV set-top box comprising a casing, a fixing frame, an adapter board, a hard disk drive, and a sliding frame. Wherein said casing is provided with an opening, the fixing frame is fixed within the casing and corresponds to the opening. The fixing frame is provided with two chutes which are parallel with each other, and which are located at two opposite sides of the fixing frame such that the ends of the parallel chutes are adjacent to the opening. The adapter board is electrically connected with a connector and is arranged on the fixing frame and is remote from the opening. The hard disk drive has a connecting head, and the sliding frame is arranged with the hard disk drive. Wherein the sliding frame is smaller than the opening of the casing such that the sliding frame can pass through the opening and be slidably arranged between the two chutes of the fixing frame. The connecting head of the hard disk drive can be correspondingly plugged into the connector of the adapter board so as to establish an electrical connection. The sliding frame is further provided with a finger-hooking element for hooking and pulling the sliding frame by a finger, through the opening and out of the casing, making the connecting head of the hard disk drive disengage from the adapter board to cease being electrically connected with each other.

As compared with the conventional digital TV set-top box, the hard disk drive, according to the present invention, is arranged on a sliding frame inside the set-top box, wherein the sliding frame can pass through the opening of the casing and be slidably arranged between the two chutes of the fixing frame. Additionally, the connecting head of the hard disk drive can be correspondingly plugged into the connector of the adapter board so as to establish an electrical connection. Further, according to the present invention, the sliding frame is provided with a finger-hooking element, by which a finger can hook and pull the sliding frame through the opening and out of the casing, making the connecting head of the hard disk drive disengage from the adapter board to cease being electrically connected with each other. As such, the present invention provides a digital TV set-top box from which the hard disk drive can be assembled or disassembled easily, so that when the hard disk drive is damaged, or the operating system, software or firmware thereof needs to be upgraded, the hard disk drive can be easily removed as described, and that maintaining or upgrading the hard disk drive of the digital TV set-top box can be performed without the need of removing the whole upper casing of the set-top box.

According to the present invention, the finger-hooking element refers to a flange, or to a finger ring, a hook ring, a hook groove, a recess, or any other structure for the finger to stretch thereinto and exert outward for pulling the sliding frame out of the casing, namely, for the finger to take the hard disk drive out from the casing easily.

Further, according to the present invention, the casing may include an upper casing and a lower casing oppositely engaged with each other so as to form an internal space therebetween. There is a backboard provided at the rear of the lower casing, and the opening is provided at the backboard on which a plurality of jacks are arranged for connecting with net routes, various output signal lines, and so forth. The casing further includes a rear lid for covering the opening correspondingly, wherein the rear lid has an elastic fastener for being engaged with the casing through elasticity, while the elastic fastener can be disengaged from the casing and moved away from the opening when depressing the elastic fastener and overcoming the elasticity. Therefore, in case the hard disk drive needs to be repaired or upgraded, consumers can disengage the elastic fastener easily and take out the original hard disk drive by the finger-hook element so as to replace it with a hard disk drive installed with upgraded software or firmware.

According to the present invention, the adapter board may further include another connector electrically connected to a power cord and a signal line. The hard disk drive may refer to a SATA hard disk drive pre-installed with an upgraded operating system, software or firmware; or to an IDE hard disk drive or other equivalent hard disk drive.

Other objects, advantages, and novel features of the present invention will become more apparent from the following detailed descriptions when taken in conjunction with the accompanying drawings.

### BRIEF DESCRIPTION OF THE DRAWINGS

FIG. 1 is a perspective view illustrating a recordable digital TV set-top box according to the present invention;

FIG. 2 is an exploded view illustrating the recordable digital TV set-top box according to the present invention;

FIG. 3 is an exploded view illustrating a hard disk drive and a sliding frame according to the present invention; and

FIG. 4 is a schematic view illustrating the recordable digital TV set-top box in use.

### DETAILED DESCRIPTION OF THE PREFERRED EMBODIMENTS

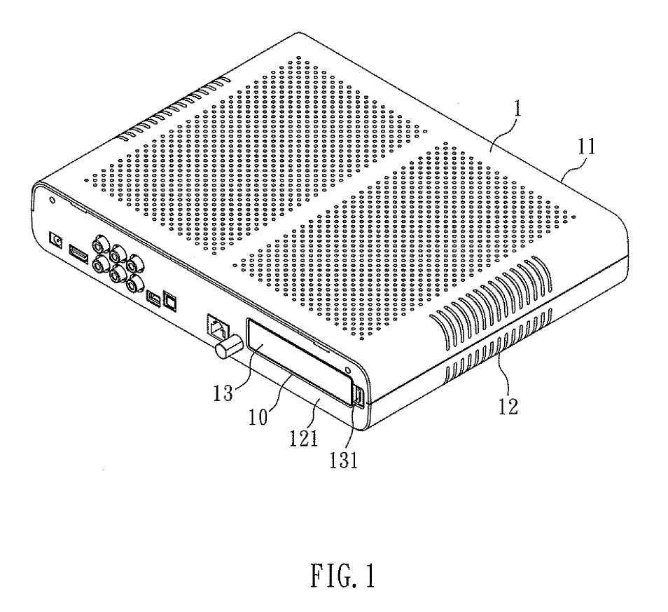

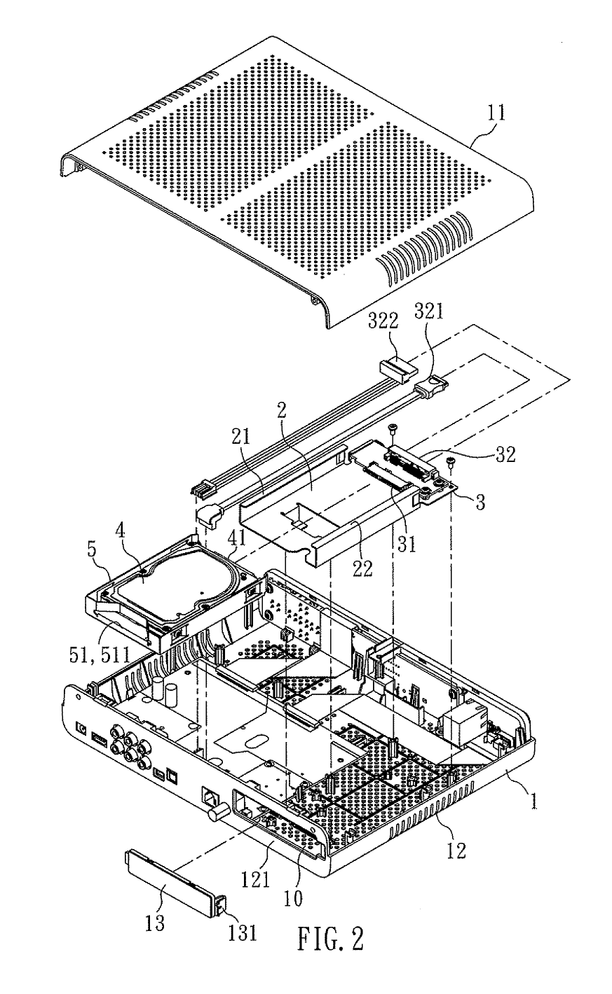

Referring to FIG. 1, a perspective view illustrating a recordable digital TV set-top box according to the present invention, and to FIG. 2, an exploded view illustrating the same, the recordable digital TV set-top comprises a casing 1, a fixing frame 2, an adapter board 3, a hard disk drive 4, and a sliding frame 5. As shown in FIG. 1, the casing 1 includes an upper casing 11 and a lower casing 12 oppositely engaged with each other so as to form an internal space therebetween. There is a backboard 121 provided at the rear of the lower casing 12, and an opening 10 is provided at the backboard 121 on which a plurality of jacks are arranged at the left side of the opening 10 (see FIG. 1) for connecting with net routes, various output signal lines, and so forth. The casing 1 is further provided with a rear lid 13 for covering the opening 10 correspondingly, wherein the rear lid 13 has an elastic fastener 131 for being engaged with the casing 1 through elasticity, while the elastic fastener 131 can be disengaged from the casing 1 and moved away from the opening 10 when depressing the elastic fastener 131 and overcoming the elasticity.

As shown in FIG. 2, the fixing frame 2 is fixed in the casing 1 and corresponds to the opening 10, wherein the fixing frame 2 is provided with two chutes 21,22 which are parallel with each other, and which are located at two opposite sides of the fixing frame 2 such that ends of the parallel chutes are adjacent to the opening 10. The fixing frame 2 is arranged with the adapter board 3 remote from the opening 10, wherein the adapter board 3 is electrically connected with a connector 31 and with another connector 32, and wherein the another connector 32 is electrically connected to a power cord 321 and a signal line 322.

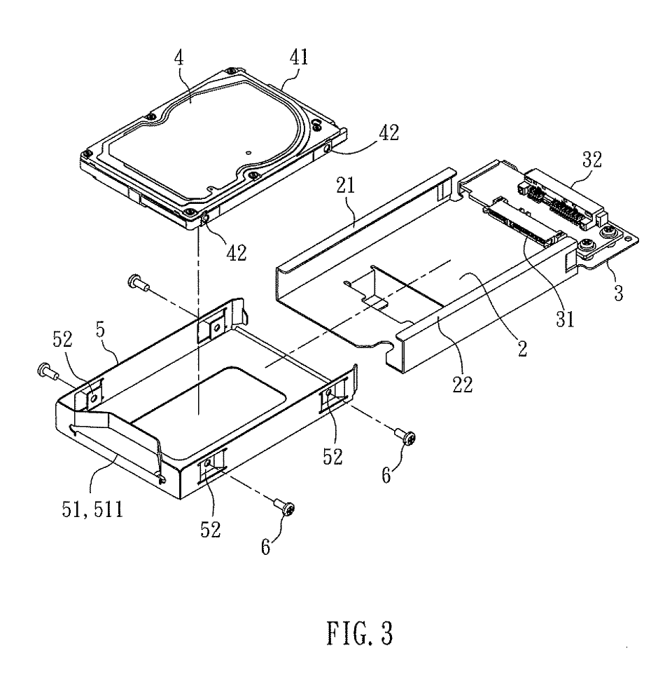

Now referring to FIG. 3, an exploded view illustrating the hard disk drive and the sliding frame according to the present invention, the hard disk drive 4 may refer to a 2.5-inch SATA hard disk drive, wherein the hard disk drive 4 is provided at its two sidewalls with four thread holes 42, and at its front end with a connecting head 41, and is pre-installed with an operating system. The sliding frame 5 is provided at its two sidewalls with four through holes 52 such that four screws 6 pass through the four through holes 52, respectively, and are fastened into the four thread holes 42 of the hard disk drive 4 so as to mount the hard disk drive 4 on the sliding frame 5.

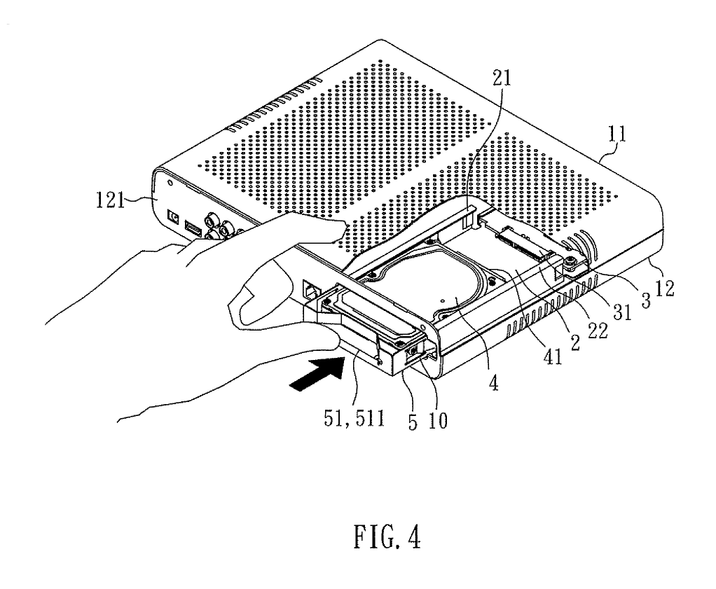

Further referring to FIG. 4, a schematic view illustrating the recordable digital TV set-top box in use, since the sliding frame 5 is smaller in size than the opening 10 of the casing 1, the sliding frame 5 can pass through the opening 10 and be slidably arranged between the two chutes 21,22 of the fixing frame 2. As shown in FIG. 4, the hard disk drive 4 has been mounted on the sliding frame 5 of the casing 1. Therefore, when the sliding frame 5 is pushed by one and moved through the opening 10 so as to be slidably disposed between the two chutes 21,22, the connecting head 41 arranged at the front end of the hard disk drive 4 can be correspondingly plugged into the connector 31 of the adapter board 3, and this will accomplish the assembly and establish an electrical connection.

As shown in FIG. 4, the sliding frame 5 is provided at its rear end with a finger-hooking element 51, namely a flange 511 according to the present invention, such that a finger can stretch thereinto and hook and pull outward the sliding frame 5 and the hard disk drive 4 through the opening 10 and out of the casing 1, making the connecting head 41 of the hard disk drive 4 disengage from the connector 31 of the adapter board 3 to cease being electrically connected with each other. This will facilitate assembling and disassembling of the hard disk drive 4 and upgrading of the operating system thereof. As such, the present invention provides a TV set-top box from which the hard disk drive 4 can be disassembled easily, so that when the hard disk drive 4 is damaged or the operating system thereof needs to be upgraded, the hard disk drive 4 can be easily removed as described. The purpose of maintaining and upgrading the hard disk drive 4 can be achieved without the need of removing the whole upper casing 11 of the set-top box.

Although the present invention has been explained in relation to its preferred embodiments, it is to be understood that many other possible modifications and variations can be made without departing from the scope of the invention as hereinafter claimed.

What is claimed is:

1. A digital TV set-top box, comprising:
a casing, being provided with an opening;
a fixing frame, being fixed in the casing and corresponding to the opening, wherein the fixing frame is provided with two parallel chutes located at two opposite sides of the fixing frame such that ends of the parallel chutes are adjacent to the opening;
an adapter board, being electrically connected with a connector and arranged on the fixing frame and being remote from the opening;
a hard disk drive, having a connecting head; and
a sliding frame, being arranged with the hard disk drive;
wherein the sliding frame is smaller than the opening of the casing such that the sliding frame can pass through the opening and be slidably arranged between the two chutes of the fixing frame, and the connecting head of the hard disk drive can be correspondingly plugged into the connector of the adapter board so as to establish an electrical connection; and
wherein the sliding frame further includes a finger-hooking element for hooking and pulling the sliding frame across the opening and out of the casing, making the connecting head of the hard disk drive disengage from the connector of the adapter board without being electrically connected with each other.

2. The digital TV set-top box as claimed in claim 1, wherein the finger-hooking element refers to a flange.

3. The digital TV set-top box as claimed in claim 1, wherein the casing includes an upper casing and a lower casing oppositely engaged with each other so as to form an internal space therebetween.

4. The digital TV set-top box as claimed in claim 1, wherein the casing further includes a rear lid for covering the opening correspondingly.

5. The digital TV set-top box as claimed in claim 4, wherein the rear lid is provided with an elastic fastener.

6. The digital TV set-top box as claimed in claim 1, wherein the adapter board further includes another connector electrically connected to a power cord and a signal line.

7. The digital TV set-top box as claimed in claim 1, wherein the hard disk drive refers to a SATA hard disk drive.
